(19) United States
(12) Patent Application Publication
(10) Pub. No.: US 2015/0295437 A1
(43) Pub. Date: Oct. 15, 2015

(54) MULTI-FUNCTION POWER SUPPLY DEVICE FOR WRISTWATCH CELL PHONE AND TABLE CELL PHONE

(71) Applicant: COREMATE TECHNICAL CO., LTD., Taoyuan County (TW)

(72) Inventor: Robert WANG, TAOYUAN COUNTY (TW)

(73) Assignee: COREMATE TECHNICAL CO., LTD., Taoyuan County (TW)

(21) Appl. No.: 14/250,892

(22) Filed: Apr. 11, 2014

(51) Int. Cl. H02J 7/00; H02J 7/02

(52) U.S. Cl. CPC H02J 7/0044; H02J 7/025

(57) ABSTRACT

A multi-function power supply device for a wristwatch cell phone and a tablet cell phone includes a main body. The main body is pivotally connected with a support board. The main body is provided with a movable board. The movable board is provided with a power supply coil. The power supply coil is electrically connected with a battery unit. The battery unit is connected with a plug. The movable board can be retracted or extended to form a first state and a second state. When in the first state, the device can be used to supply power to a wristwatch cell phone. When in the second state, the device can be used to supply power to a tablet cell phone. The multi-function power supply device of the present invention can be used conveniently for supplying power to a wristwatch cell phone and a tablet cell phone respectively.

### BACKGROUND OF THE INVENTION

1. Field of the Invention

The present invention relates to a power supply device, and more particularly to a multi-function power supply device for a wristwatch cell phone and a tablet cell phone.

2. Description of the Prior Art

A cell phone is a common portable communication apparatus. With the development of science and technology, the functions of the cell phone are increased day by day. These days, people rely on a cell phone increasingly. A cell phone becomes an essential appliance for the modern life. For the user to carry the cell phone conveniently and to use the cell phone at any time, different types and different functions of cell phones are developed accordingly. A wrist watch cell phone and a tablet cell phone become a mainstream trend.

In general, different types of cell phones must cooperate with different power supply devices to supply power. When the user replaces a cell phone or owns at least two different types of cell phones, he/she has to use different power supply devices. The user may own a number of power supply devices, which becomes a trouble for the user. When the different cell phones need to be charged, the user has to use different power supply devices to cause great inconvenience. Accordingly, the inventor of the present invention has devoted himself based on his many years of practical experiences to solve this problem.

### SUMMARY OF THE INVENTION

The primary object of the present invention is to provide a multi-function power supply device for a wristwatch cell phone and a tablet cell phone. The multi-function power supply device can be used conveniently for supplying power to a wristwatch cell phone and a tablet cell phone respectively.

In order to achieve the aforesaid object, the multi-function power supply device for a wristwatch cell phone and a tablet cell phone of the present invention comprises a main body. The main body is pivotally connected with a support board. The top side of the support board is formed with a slide trough. The main body is provided with a movable board disposed in the slide trough. The movable board is slidable in the slide trough. The main body comprises a pair of curved wings which are pivotally connected to left and right sides of the support board. The rear of the main body is pivotally connected with a plug. A battery unit is provided in the main body. The battery unit is electrically connected with the plug for storing power. A power supply coil is provided in the movable board. The power supply coil is electrically connected with the battery unit.

The movable board of the multi-function power supply device for a wristwatch cell phone and a tablet cell phone of the present invention is selective to be retracted into the slide trough to form a first state or extended to the top side of the support board to form a second state. When the multi-function power supply device is in the first state and a wristwatch cell phone is placed on the support board, the multi-function power supply device will supply power to the wristwatch cell phone. When the multi-function power supply device is in the second state and a tablet cell phone is placed on the support board and the movable board, the multi-function power supply device will supply power to the tablet cell phone.

### BRIEF DESCRIPTION OF THE DRAWINGS

FIG. 1 is a perspective view of the present invention;

FIG. 2 is a schematic view of a first state of the present invention;

FIG. 3 is a schematic view of a second state of the present invention;

FIG. 4 is a schematic view of the first state of the present invention when in use;

FIG. 5 is another schematic view of the first state of the present invention when in use, showing the wristwatch cell phone held and positioned on the present invention;

FIG. 6 is a schematic view of the second state of the present invention when in use;

FIG. 7 is a schematic view showing the open insertion trough of the present invention; and

FIG. 8 is a schematic view showing the use of the insertion trough of the present invention.

### DETAILED DESCRIPTION OF THE PREFERRED EMBODIMENTS

Embodiments of the present invention will now be described, by way of example only, with reference to the accompanying drawings.

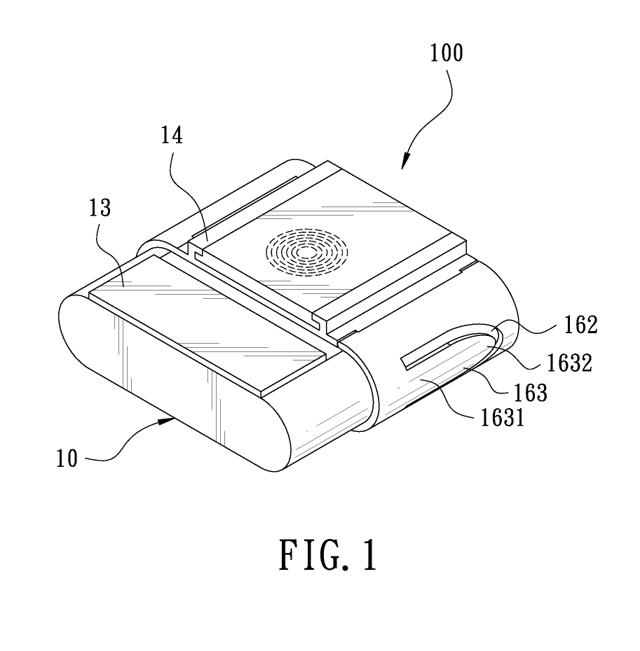

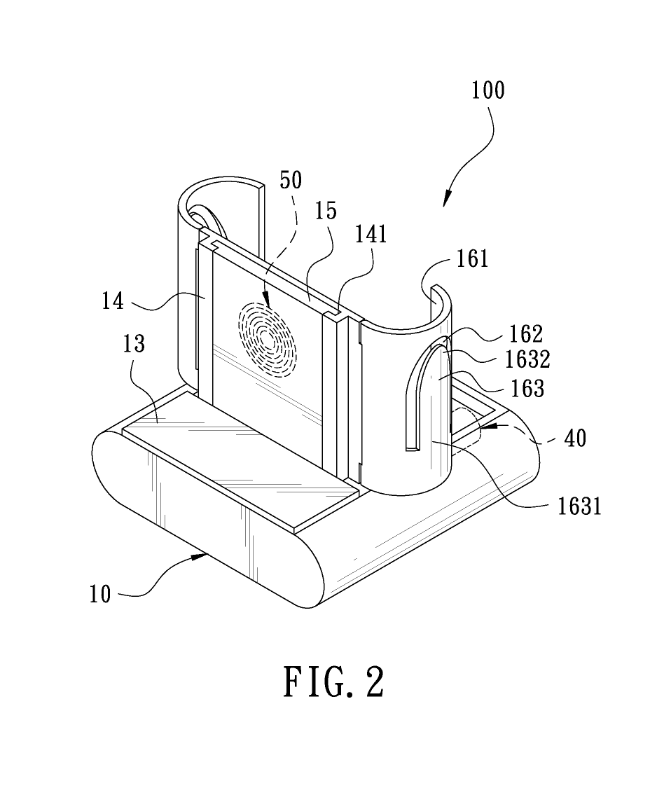

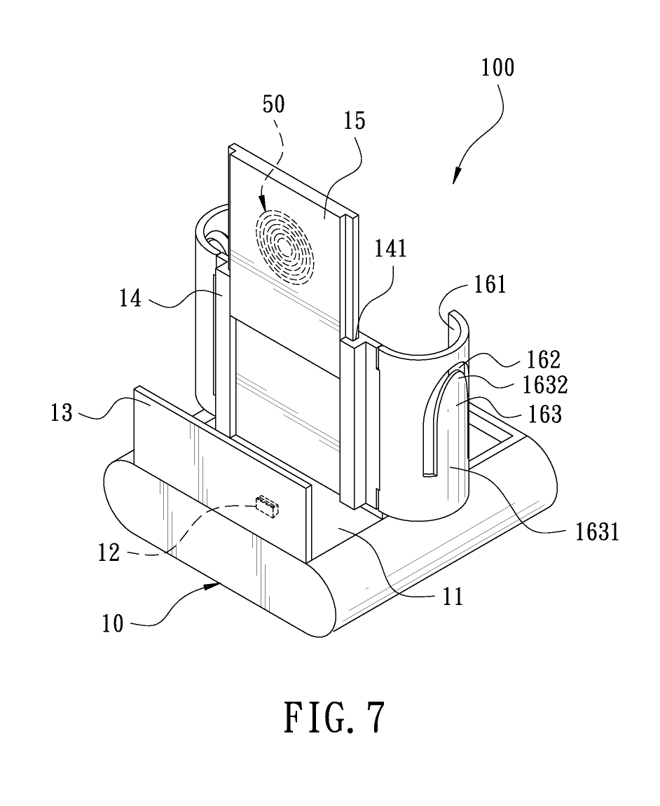

FIG. 1 is a perspective view of the present invention. FIG. 2 is a schematic view of a first state of the present invention. FIG. 7 is a schematic view showing the open insertion trough of the present invention. The present invention discloses a multi-function power supply device 100 for a wristwatch cell phone and a tablet cell phone. The multi-function power supply device 100 for a wristwatch cell phone and a tablet cell phone comprises a main body 10, a plug, an electric connector, a battery unit 40, and a power supply coil 50.

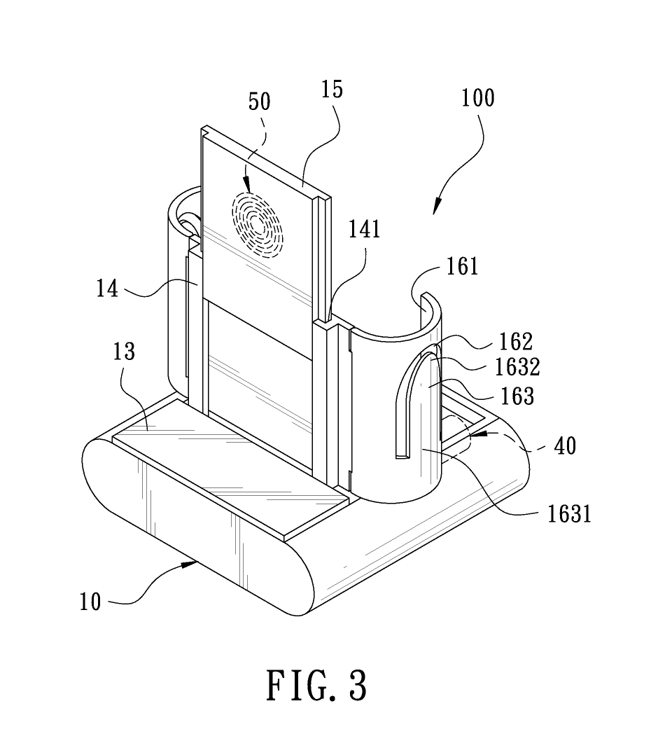

The main body 10 has an insertion trough 11 thereon and a USB plug 12 disposed at the bottom of the insertion trough 11. In the present invention, the insertion trough 11 is disposed at the front side of the top of the main body 10. The main body 10 comprises a lid 13 which is pivotally connected to the front edge of the insertion trough 11. The lid 13 is selective to cover the insertion trough 11. The main body 10 comprises a support board 14 which is pivotally connected to the rear edge of the insertion trough 11. The top side of the support board 14 is formed with a slide trough 141. The main body 10 is provided with a movable board 15 disposed in the slide trough 141. The movable board 15 is slidable in the slide trough 141. The movable board 15 can be retracted into the slide trough 141 to form a first state or extended to the top side of the support board 14 to form a second state, as shown in FIG. 3. The main body 10 comprises a pair of curved wings 16 which are pivotally connected to the left and right sides of the support board 14. The pair of curved wings 16 curve toward the rear side of the support board 14. The curved radian of the pair of curved wings 16 relative to the support board 14 is adjustable through the connecting pivots between the pair of curved wings 16 and the support board 14. The curved apex of each of the pair of curved wings 16 is formed with a reverse U-shaped cut groove 162. Through the reverse U-shaped cut groove 162, each of the pair of curved wings 16 is formed with a holding piece 163. Two ends of the holding piece 163 are to define a connecting end 1631 and a free end 1632, respectively. The connecting end 1631 of the holding piece 163 is connected with the curved wing 16. The free end 1632 of the holding piece 163 is located at the inner side of the reverse U-shaped cut groove 162. In detail, the reverse U-shaped cut groove 162 is in a reverse U shape when the support board 14 is pivoted to be perpendicular to the main body 10. One end of the holding piece 163, close to the top side of the support board 14, is the free end 1632, and the other end is the connecting end 1631. The distal end of each of the pair of curved wings 16 has a flange 161. When the support board 14 is pivoted to attach to the top surface of the main body 10, the flanges 161 of the pair of curved wings 16 are engaged with the bottom surface of the main body 10.

The plug is pivotally connected to the rear of the main body 10. When not in use, the plug can be pivoted to the bottom of the main body 10. In the present invention, the plug is pivotally connected to the bottom of the rear of the main body 10.

The electric connector is provided at the rear of the main body 10 for connecting with an external power source. In the present invention, the electric connector is a USB connector. One end of the electric connector is plugged to the bottom of the rear of the main body 10, and the other end is electrically connected with a computer or other external power sources.

The battery unit 40 is disposed in the main body 10. The battery unit 40 is electrically connected with the plug and the electric connector for storing power.

The power supply coil 50 is disposed in the movable board 15. The power supply coil 50 is electrically connected with the battery unit 40.

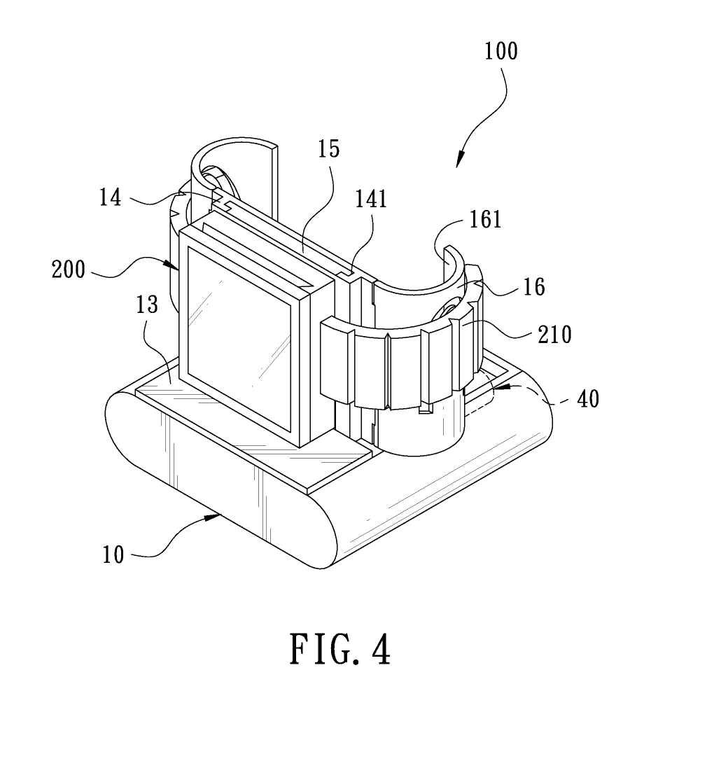

Referring to FIG. 4 and FIG. 2, when the multi-function power supply device 100 is used for supplying power to a wristwatch cell phone, the plug is first pivoted out to connect with the mains power supply. After that, the support board 14 is pivoted to be substantially perpendicular to the top surface of the main body 10, and the movable board 15 is retracted into the slide trough 141 to form the first state. A wristwatch cell phone 200 can be placed on the main body 10 and lean against the movable board 15, and the wristwatch band 210 of the wristwatch cell phone 200 can be held by the curved wings 16 so as to supply power to the wristwatch cell phone 200.

When the multi-function power supply device 100 is used for supplying power to the wristwatch cell phone 200, through the plug and by using the mains power supply, it supplies the required power. The electricity is stored through the battery unit 40 and converted to the required power for the wristwatch cell phone 200 and then supplies to the power supply coil 50. By the power supply coil 50, the electricity is converted to magnetism. The induction coil inside the wristwatch cell phone 200 will generate electricity due to electromagnetic induction, and the electricity is supplied to the wristwatch cell phone 200. This can supply power to the wristwatch cell phone 200.

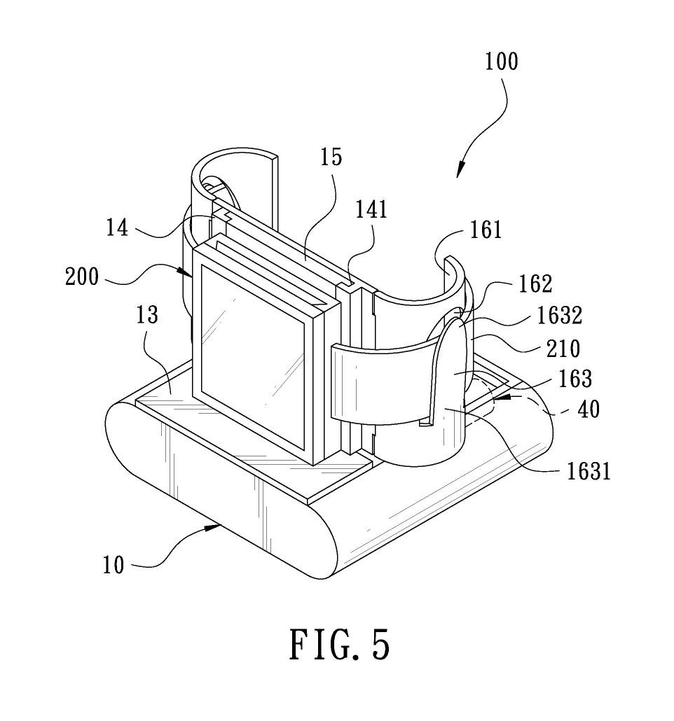

Referring to FIG. 5 and FIG. 2, the free end 1632 of the holding piece 163 can be slightly pulled outward by the user, and then the wristwatch band 210 of the wristwatch cell phone 200 can be engaged in the reverse U-shaped groove 162 from the top of each holding piece 163. The wristwatch band 210 of the wristwatch cell phone 200 can be held by the inner side of each holding piece 163 to be positioned on the pair of curved wings 16, such that the wristwatch cell phone 200 is stably positioned on the multi-function power supply device 100 and leans against the movable board 15 stably.

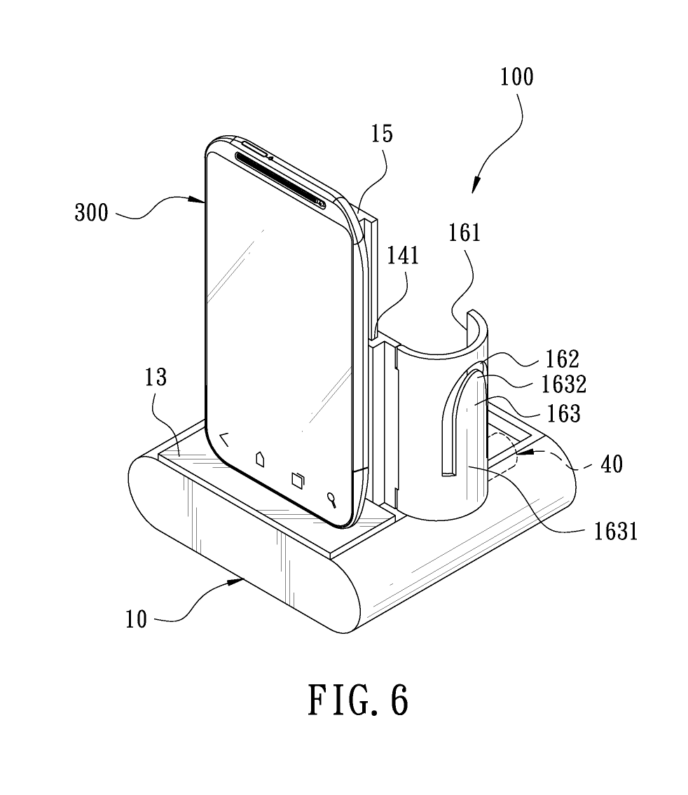

Referring to FIG. 6 and FIG. 3, when the multi-function power supply device 100 is used for supplying power to a tablet cell phone, the movable board 15 is extended out from the support board 14 to the top side of the support board 14 to form the second state, such that a tablet cell phone 300 can be placed on the main body 10 and leans against the support board 14 and the movable board 15 for supplying power to the tablet cell phone 300.

When the multi-function power supply device 100 is used for supplying power to the tablet cell phone 300, through the plug and by using the mains power supply, it supplies the required power. The electricity is stored through the battery unit 40 and converted to the required power for the tablet cell phone 300 and then supplies to the power supply coil 50. By the power supply coil 50, the electricity is converted to magnetism. The induction coil inside the tablet cell phone 300 will generate electricity due to electromagnetic induction, and the electricity is supplied to the tablet cell phone 300. This can supply power to the tablet cell phone 200.

It is noted that, no matter the multi-function power supply device 100 is in the first state or the second state, the movable board 15 is exposed out of the front side of the support board 14 for the wristwatch cell phone 200 and the tablet cell phone 300 to direct contact with the movable board 15, such that the power supply coil 50 embedded in the movable board 15 can approach the wristwatch cell phone 200 and the tablet cell phone 300 to enhance the power supply function of the multi-function power supply device 100 for the wristwatch cell phone 200 and the tablet cell phone 300.

It is noted that the multi-function power supply device 100 uses the mains power supply to supply the required power through the plug, alternatively, it can be connected with a computer or other external power sources to supply the required power through the electric connector.

Besides, referring to FIG. 2 and FIG. 6, the multi-function power supply device 100 can use the electricity stored in the battery unit 40 to supply power to the wristwatch cell phone 200 and the tablet cell phone 300, without using the mains power supply through the plug or connecting with a computer or other external power sources to supply the required power through the electric connector.

It is noted that the battery unit 40 can be a conventional dry battery. The multi-function power supply device 100 can directly use the electricity of the dry battery to supply power to the wristwatch cell phone 200 and the tablet cell phone 300.

Therefore, the multi-function power supply device 100 not only enhances the interchangeability of the cell phones but also provides more selectivity of the cell phones for the user.

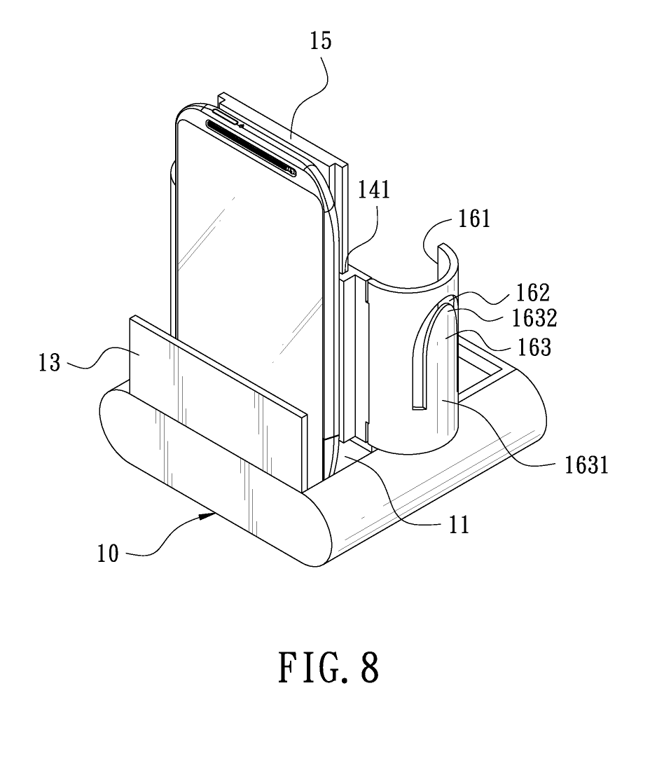

Referring to FIG. 7 and FIG. 8, the lid 13 of the multi-function power supply device 100 can be pivoted to be substantially perpendicular to the top surface of the main body 10 for the tablet cell phone 300 or the wristwatch cell phone 200 to be inserted in the insertion trough 11. Through the USB plug 12, the tablet cell phone 300 or the wristwatch cell phone 200 is connected with the multi-function power supply device 100, such that the tablet cell phone 300 or the wristwatch cell phone 200 can be connected with a computer or other external devices through the electric connector of the multi-function power supply device 100. Moreover, when the multi-function power supply device 100 supplies power, it can be connected with a computer or other external devices

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A multi-function power supply device for a wristwatch cell phone and a tablet cell phone, comprising:
a main body, the main body being pivotally connected with a support board, a top side of the support board being formed with a slide trough, the main body being provided with a movable board disposed in the slide trough, the movable board being slidable in the slide trough, the main body comprising a pair of curved wings which are pivotally connected to left and right sides of the support board;
a plug, the plug being pivotally connected to a rear of the main body;
a battery unit, the battery unit being disposed in the main body, the battery unit being electrically connected with the plug for storing power; and
a power supply coil, the power supply coil being disposed in the movable board, the power supply coil being electrically connected with the battery unit;
wherein, the movable board is selective to be retracted into the slide trough to form a first state or to be extended to the top side of the support board to form a second state for supplying power to a wristwatch cell phone or a tablet cell phone respectively.

2. The multi-function power supply device for a wristwatch cell phone and a tablet cell phone as claimed in claim 1, each of the pair of curved wings is formed with a reverse U-shaped cut groove, the reverse U-shaped cut groove is in a reverse U shape when the support board is pivoted to be perpendicular to the main body, through the reverse U-shaped cut groove, each of the pair of curved wings is formed with a holding piece, one end of the holding piece, close to the top side of the support board, is a free end, and another end of the holding piece is a connecting end.

3. The multi-function power supply device for a wristwatch cell phone and a tablet cell phone as claimed in claim 1, wherein a distal end of each of the pair of curved wings has a flange, when the support board is pivoted to attach to a top surface of the main body, the flanges of the pair of curved wings are engaged with a bottom surface of the main body.

4. The multi-function power supply device for a wristwatch cell phone and a tablet cell phone as claimed in claim 1, wherein the main body has an insertion trough thereon, the insertion trough is disposed at a front side of the support board, the main body is provided with a USB plug disposed at a bottom of the insertion trough, the main body is provided with a lid which is pivotally connected to a side edge of the insertion trough, and the lid is selective to cover the insertion trough.

5. The multi-function power supply device for a wristwatch cell phone and a tablet cell phone as claimed in claim 1, further comprising an electric connector, the electric connector being disposed at the rear of the main body, one end of the electric connector being electrically connected with the battery unit, another end of the electric connector being electrically connected with an external power source.

6. The multi-function power supply device for a wristwatch cell phone and a tablet cell phone as claimed in claim 5, wherein the electric connector is a USB connector.
